(19) United States
(12) Patent Application Publication
(10) Pub. No.: US 2003/0120561 A1
(43) Pub. Date: Jun. 26, 2003

(54) System and method for displaying menu

(75) Inventor: Kazuyoshi Asada, Kawasaki-shi (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/326,417

(22) Filed: Dec. 23, 2002

(30) Foreign Application Priority Data
Dec. 26, 2001 (JP) JP2001-393146

(51) Int. Cl. G06F 17/60

(52) U.S. Cl. 705/27; 705/15

(57) ABSTRACT

A menu displaying system and method is provided that can display timely information about articles recommended to customers by the shop side and quickly information about articles required by the customer. In the input terminal 10, when the input section 12 receives article information, the controller 13 transmits an update request, which requests updating the reference information database 32A in the server 30, and the article information, to the server 30. In response to the update request and the article information, the controller 33 in the server 30 updates the reference information database 32A in the storage 32, based on the article information, according to the reference information data creation program 32B. In the ordering terminal 20, the controller 23 transmits the order information and the customer information input to the input section 22, to the server 30. In the server 30, the controller 33 updates the reference information database 32A in the storage 32, based on the order information and the customer information, according to the reference information data creation program 32B. The controller 33 creates the menu information according to the reference information data creation program 32B and then transmits it to the display terminal 40. In the display terminal 40, the controller 43 displays the menu information from the server 30 on the display 42.

### BACKGROUND OF THE INVENTION

The present invention relates to a technique for displaying an article menu on a display terminal installed at, for example, a customer table. More particularly, the present invention relates to a menu displaying system and method for preferentially displaying information about articles recommended by a shop side on a display terminal.

Generally, when a customer orders an article (dish) in a restaurant, the customer refers to a paper-made menu sheet handed over by a waiter, on which names and photographs of articles are printed, to choose the customer's favorite item.

However, the paper-made menu sheet has the disadvantage in that the content thereof cannot be easily rewritten. That is, items recommended by the shop side cannot be shown on the menu sheet in real time. A popular article list or a popular article list classified by man or woman or by age cannot be placed on the menu sheet.

Moreover, because the order of articles listed on the paper menu sheet is one-sidedly determined according to the shop side's convenience, the customer cannot quickly find information about his desired item. For example, because sets of information about items are not arranged by price on the paper menu sheet, the customer having limited spending cannot quickly determine the item affordable with the remainder of the money.

### SUMMARY OF THE INVENTION

The present invention is made to solve the above-mentioned problems. An object of the present invention is to provide a menu displaying system for capable of timely displaying information about articles recommended to customers by a shop side or for capable of quickly displaying information about articles required by customers.

Another object of the present invention is to provide a menu displaying method for capable of timely displaying information about articles recommended to customers by a shop side or for capable of quickly displaying information about articles required by customers.

In the first aspect of the present invention, a menu displaying system comprises an ordering terminal, a display terminal installed at a customer table, a server, and a communication line for interconnecting the ordering terminal, the display terminal, and the server. The ordering terminal includes input means for inputting order information about an order from a customer and customer information about a feature of the customer, and transmission means for transmitting the order information and the customer information input by the input means, to the server. The server includes a storage and a controller. The storage stores article information about articles and order management information representing the order quantity of articles classified according to customer's features, in one-to-one correspondence. The controller updates the order quantity of the order management information based on order information and customer information transmitted from the order terminal, creates menu information representing sales of articles according to a customer's feature based on the article information and the order management information stored in the storage, and then transmits the menu information to the display terminal. The server includes a display for manifesting menu information transmitted from the server.

In the menu displaying system, the display terminal comprises input means for choosing a predetermined menu item from among menu items for article information display manifested on the display, and a controller for controllably transmitting an article information transmission request to the server. The request requests transmitting article information about the menu item chosen with the input means to its own terminal. The controller in the server retrieves required article information from the storage, based on the article information transmission request from the display terminal, and then transmits the retrieved article information as menu information to the display terminal.

In the second aspect of the present invention, a menu displaying system comprises an ordering terminal, a server, and a communication line for interconnecting the ordering terminal and the server. The ordering terminal includes input means for inputting order information about an order from a customer and customer information about a feature of the customer, a display for manifesting menu information, and transmission means for transmitting the order information and the customer information input by the input means, to the server and manifesting menu information transmitted from the server. The server includes a storage for storing article information about articles and order management information representing the order quantity of articles classified according to customer's features, in one-to-one correspondence, and a controller for updating the order quantity of the order management information stored in the storage based on order information and customer information transmitted from the order terminal, creating menu information representing sales of articles according to a customer's feature based on the article information and the order management information stored in the storage, and then transmitting the menu information to the ordering terminal.

The menu displaying system further comprises an input terminal including input means for inputting recommendation information about an article recommended to a customer and transmission means for transmitting the recommendation information input by the input means to the server. The controller in the server updates article information stored in the storage based on the recommendation information from the server and then creates menu information about the article recommended to the customer based on the article information stored in the storage.

In the third aspect of the present invention, a menu displaying method suitable for a system including an ordering terminal, a server, and a display terminal installed at a customer table, comprises the steps of storing article information about articles and order management information into the server in one-to-one correspondence, the order management information representing the order quantity of articles according to customer's features; transmitting order information about orders and customer information about customer's features, input in the ordering terminal, to the server; updating the order management information stored in the server, based on the order information and the customer information from the ordering terminal; creating menu information, based on the article information and the order management information stored in the server, the menu information representing article sales according to customer's features; transmitting the menu information created in the server to the display terminal; and manifesting the menu information from the server on the display terminal.

The menu displaying method further comprises the steps of, when a predetermined menu item is chosen from among menu items representing article information on the display terminal, transmitting an article information transmission request to the server, the article information transmission request requesting transmitting article information about the chosen menu item to its own terminal; retrieving requested article information from the storage in the server, based on the article information transmission request from the display terminal; transmitting the article information retrieved as menu information to the display terminal by means of the server; and manifesting menu information from the server, in the display terminal.

In the fourth aspect of the present invention, a menu displaying method suitable for a system including an ordering terminal and a server comprises the steps of storing article information about articles and order management information into the server in one-to-one correspondence, the order management information representing the order quantity of articles according to customer's features; transmitting order information about orders input in the ordering means and customer information about customer's features to the server; updating order management information stored in the server, based on the order information and the customer information from the ordering terminal; creating menu information based on the article information and the order management information stored in the server, the menu information representing article sales according to customer's features; transmitting said menu information created in the server, to the ordering terminal; and manifesting the menu information from the server, in the ordering terminal.

The menu displaying method further comprises the steps of inputting recommendation information about articles recommended to customers in the input terminal, transmitting said recommendation information input in the input terminal, updating article information stored in the server based on the recommendation information from the input terminal, and creating menu information about articles recommended to customers, based on display information stored in the server.

### BRIEF DESCRIPTION OF THE DRAWINGS

This and other objects, features and advantages of the present invention will become more apparent from the following detailed description taken in conjunction with the attached drawings, in which:

FIG. 1 is a block diagram schematically illustrating a menu displaying system according to a first embodiment of the present invention;

FIG. 2 is a block diagram illustrating in detail the menu displaying system of FIG. 1;

FIG. 3 is a table listing a reference information database;

FIG. 4 is a flowchart explaining the operation of the menu displaying system according to the first embodiment;

FIG. 5 is a flowchart explaining the operation of the menu displaying system according to the first embodiment;

FIG. 6 is a diagram explaining information about dishes displayed on a display terminal;

FIG. 7 is a block diagram illustrating a display terminal;

FIG. 8 is a flowchart explaining the operation of a menu displaying system in a second embodiment;

FIG. 9 is a block diagram of an ordering terminal; and

FIG. 10 is a flowchart explaining the operation of a menu displaying system in a third embodiment.

### DESCRIPTION OF THE EMBODIMENTS

A menu displaying system according to the present invention will be described below by referring to the attached drawings.

In the first embodiment, the server installed at a shop stores information about items recommended to customers by the shop side or information about popular items (or reference information). The display terminal installed at each customer table displays reference information stored in the server.

The menu displaying system in the first embodiment will be described in detail below.

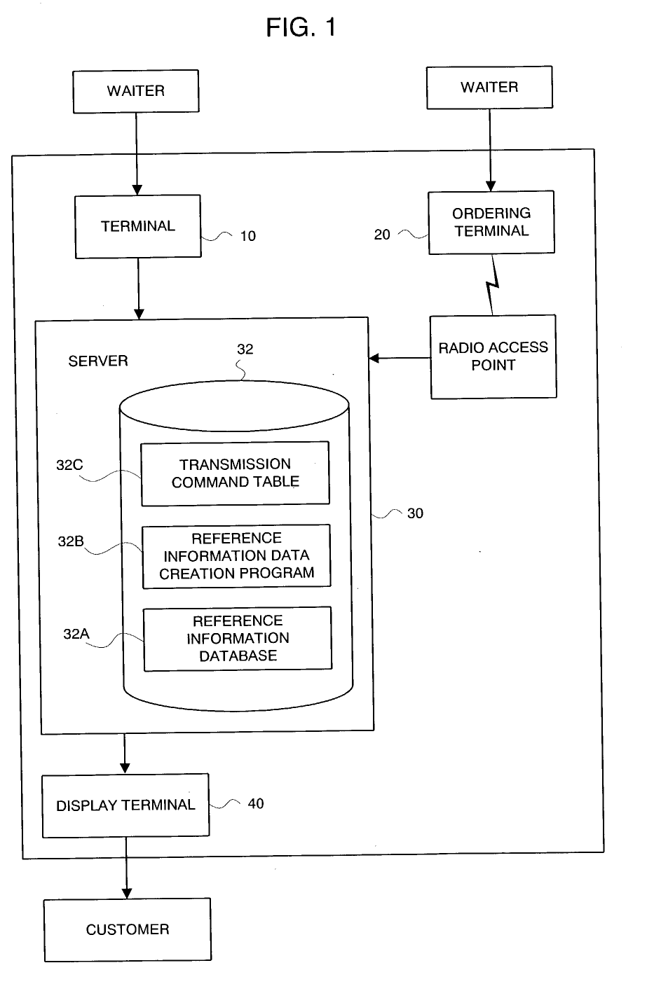

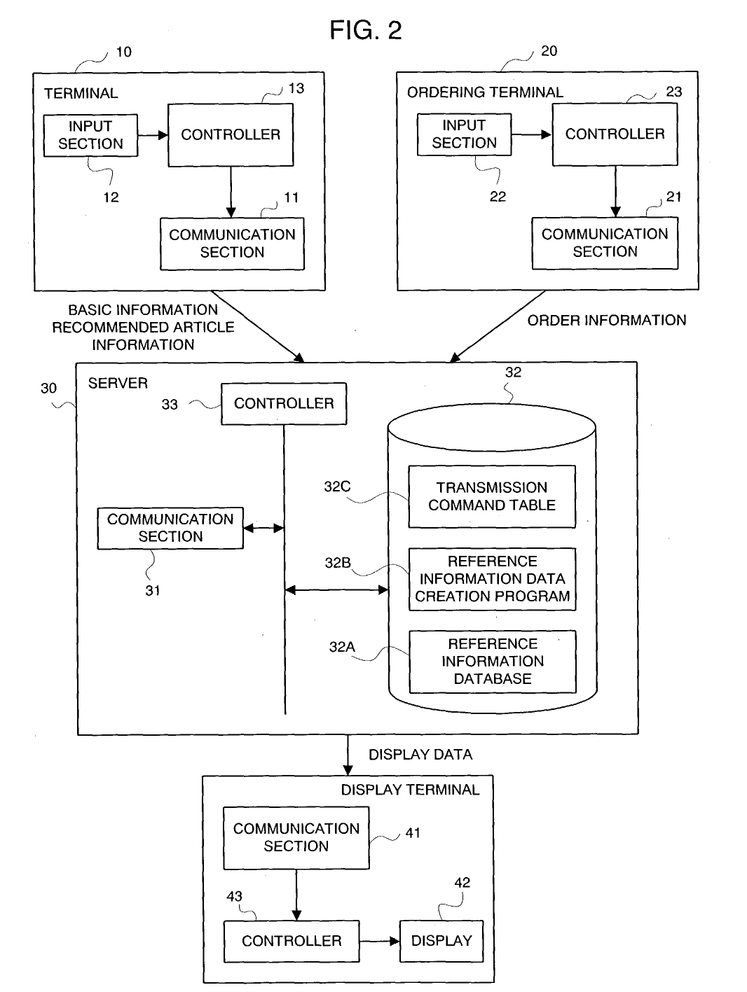

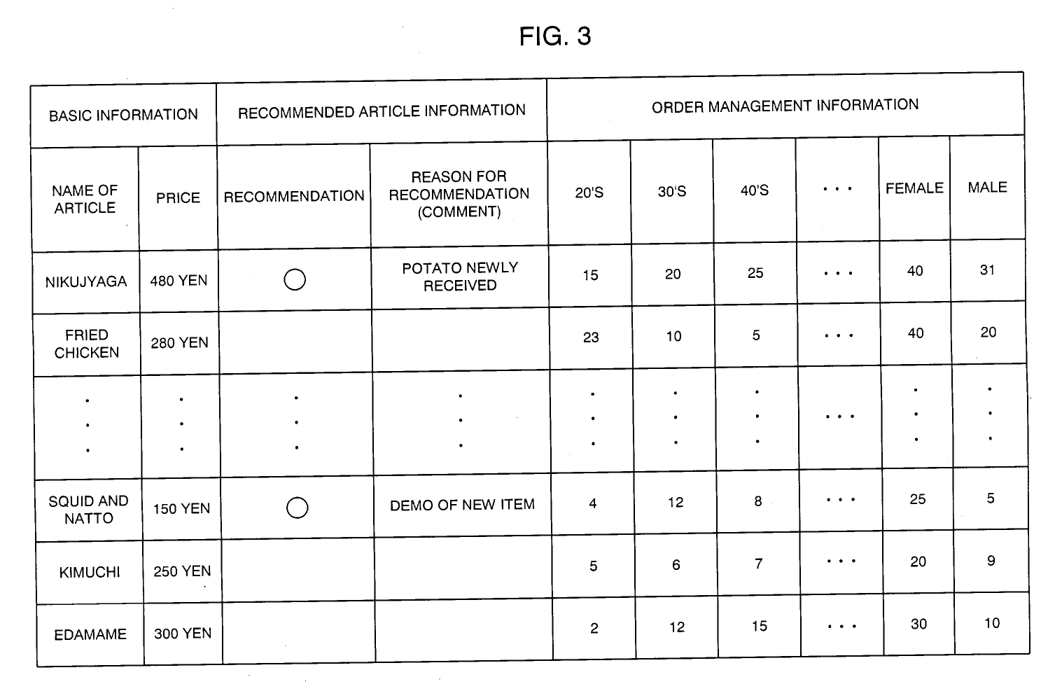

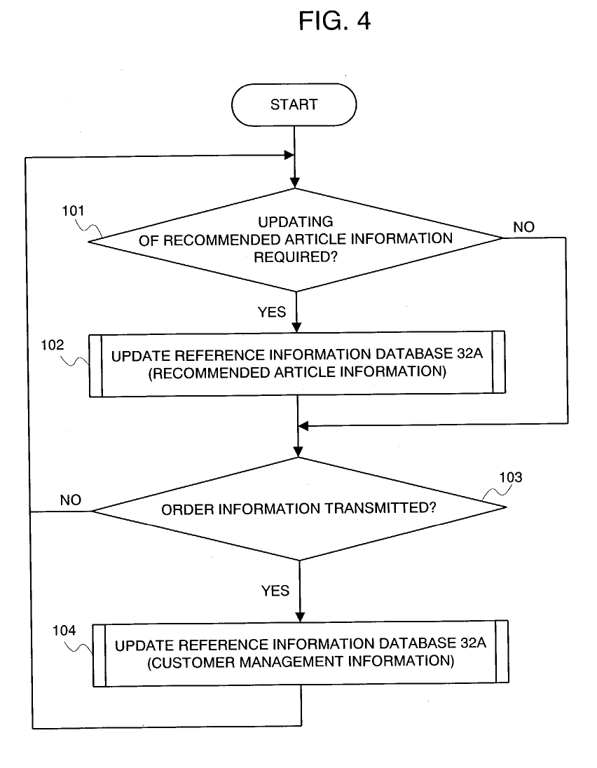

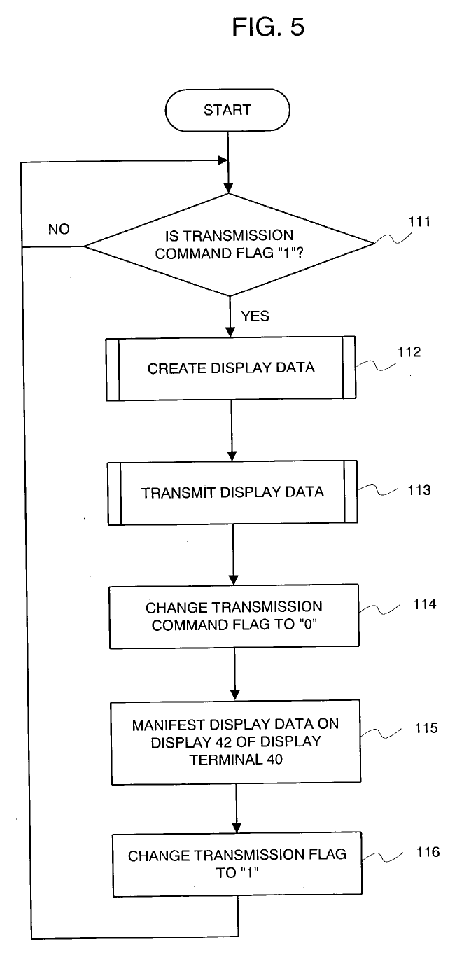

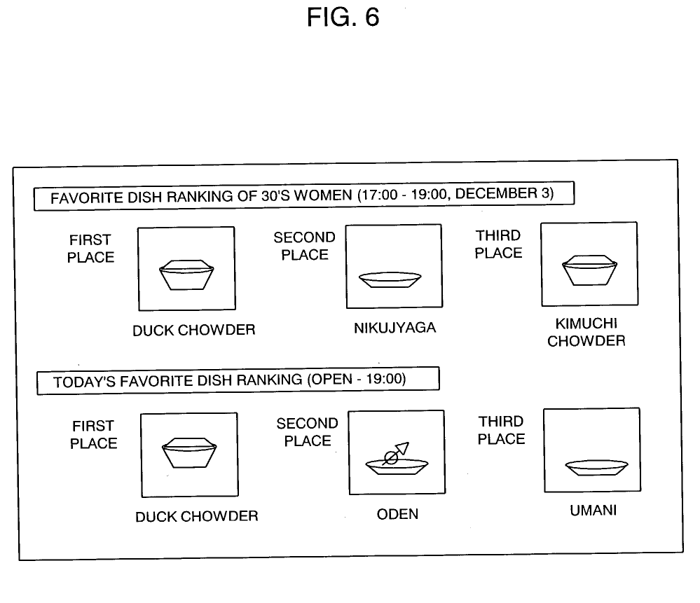

FIGS. 1 to 5 show the first embodiment of the present invention. FIGS. 1 and 2 are block diagrams each schematically illustrating a menu displaying system. FIG. 3 shows a flow chart explaining the reference information database. FIGS. 4 and 5 are flowcharts each explaining the operation of the menu displaying system. FIG. 6 is a diagram illustrating the menu displayed on the displaying terminal.

Referring to FIGS. 1 to 5, numeral 10 represents an input terminal that inputs various types of information shown from the shop side to customers, to the server 30. The input terminal 10 includes is, for example, a personal computer having a communication section 11, an input section 12, and a controller 13.

Numeral 20 represents an ordering terminal that inputs contents ordered by a customer. The ordering terminal 20 includes a communication section 21, an input section 22 (e.g. a touch panel, a voice inputting device, a keyboard, a mouse, or an OCR (Optical Character Reader)), and a controller 23.

Numeral 30 represents a server that registers reference information provided by the customer. The server 30 is, for example, a work station server that includes a communication section 31, a storage 32, and a controller 33.

Numeral 40 represents a display terminal installed at a customer table. The display terminal 40 includes a communication section 41, a display 42 (e.g. an X-ray tube monitor or a liquid crystal monitor), and a controller 43.

A network (e.g. a radio LAN or cable LAN) interconnects the input terminal 10, the ordering terminal 20, the server 30, and the display terminal 40.

In the input terminal 10, the controller 13 transmits article information input with the input section 12 to the server 30 via the communication section 11.

The article information means information including basic information and recommended article information. The basic information is information including names of items and prices thereof. The name of each item is associated with the photograph (image) thereof. The recommended article information corresponds to information including the presence or absence of recommendation and the reason thereof.

In the ordering terminal 20, the controller 23 transmits order information and customer information, input by the input section 22, to the server 30 via the communication section 21.

The order information is information including the name and quantity of an item ordered by a customer. The customer information is information including the sex (man or woman) and age (in teens, in twenties, . . . ) of an order customer.

In the server 30, the storage 32 stores a reference information database 32A, a reference information data creation program 32B, and a transmission command table 32C.

As shown in FIG. 3, the reference information database 32A is a database that tabulates basic information, recommended article information, and order management information, in one-to-one correspondence.

The order management information includes the order quantity of articles classified by man or by woman and the order quantity of articles classified by age.

According to the reference information data creation program 32B, the controller 33 in the server 30 updates the reference information database 32A based on article information from the input terminal 10 or order information and customer information from the ordering terminal 20. Moreover, the reference information data creation program 32B creates menu information based on basic information, recommended article information and/or order management information, according to the transmission command flag stored in the transmission command table 32C. According to the reference information data creation program 32B, the controller 33 transmits the created menu information to the display terminal 40. The menu information means information that manifests an article menu on the display 42 of the display terminal 40. The content of menu information is determined by the type of a predetermined menu (e.g. a favorite ranking classified by age or a recommended menu) and is changed timely.

Moreover, the reference data creation program 32B directs the controller 33 in the server 30 to rewrite the transmission command flag stored in the transmission command table.

The transmission command table 32C stores a transmission command flag to decide whether or not menu information is transmitted to the display terminal 40. When the transmission command flag is, for example “1”, the menu information is transmitted to the display terminal 40. When the transmission command flag is, for example “0”, the menu information is not transmitted to the display terminal 40.

In the server 30, when receiving article information from the input terminal 10 or order information and customer information from the ordering terminal 20, the controller 33 updates the reference information database 32A according to the reference information data creation program 32B. According to the reference information data creation program 32B, the controller 33 checks whether or not the transmission command flag stored in the transmission command table 32C is “1”. When the transmission command flag is “1”, the controller 33 creates menu information according to the type of a predetermined menu and then transmits the created menu information to the display terminal 40 via the communication section 31.

In the display terminal 40, when receiving menu information from the server 30 via the communication section 41, the controller 43 manifests the received menu information on the display 42.

Next, the operation of the menu displaying system will be described below by referring to FIGS. 4 and 5.

First, the operation to update the reference information database 32A in the storage 32 of the server 30 will be explained below.

A waiter enters article information (basic information or recommended article information), using the input section 12 of the input terminal 10. For example, a waiter enters basic information (“Nikujyaga” (a Japanese food using beef and potatoes cooked) as an article name and “480 yen” as a price) and recommended article information (“Nikujyaga” as a recommended article name and “fresh potatoes newly received” as a reason for recommendation). Thus, the controller 13 in the input terminal 10 transmits an update request which requests updating the reference information database 32A in the server 30 and the article information input to the input section 12 to the server 30 via the communication section 11.

In the server 30, the controller 33 waits for an update request transmitted from the input terminal 10 or order information and customer information transmitted from the ordering terminal 20, according to the reference information data creation program 32B.

When receiving the update request from the input terminal 10, the controller 33 updates the reference information database 32A in the storage 32, according to the reference information data creation program 32B. That is, the controller 33 updates the basic information and/or the recommended article information stored in the reference information database 32A, based on the article information from the input terminal 10 (in steps 101 and 102).

Moreover, the waiter enters order information and customer information to the input section 22 of the ordering terminal 20, according to a customer order. For example, when a customer orders a dish of “Nikujyaga” and is a woman in thirties, the waiter enters order information (about an article name of “Nikujyaga” and an order quantity of “1”) and customer information (about sex “female” and age “in thirties”) to the input section 22 of the ordering terminal 20. The controller 23 in the ordering terminal 20 transmits the order information and customer information to the server 30 via the communication section 21.

In the server 30, the controller 33 waits for an update request from the input terminal 10 or the order information and the customer information transmitted from the ordering terminal 20.

When receiving the order information and the customer information transmitted from the ordering terminal 20, the controller 33 updates the order management information stored in the reference information database 32A in the storage 32, according to the reference information data creation program 32B. For example, let us now consider that the order information corresponds to an article name of “Nikujyaga” and an order quantity of “1” and that the customer information corresponds to sex of “female” and age “in thirties”. In this case, the controller 33 in the server 30 retrieves “Nikujyaga” from the columns of article name stored in the reference information database 32A. Moreover, the controller 33 increments the column of woman and the column of 30's age, associated with the retrieved article name column (Nikujyaga), by 1 (steps 103 and 104).

Thus, the reference information database 32A stored in the storage 32 within the server 30 is updated at any time.

Next, the operation of manifesting an article menu on the display terminal 40 will be explained below.

The operation of updating the reference information database 32A in stored in the storage 32 of the server 30 and the operation of manifesting the article menu on the display terminal 40 are performed independently of each other.

In the server 30, the server 33 checks whether or not the transmission command flag stored in the transmission command table 32C is “1” according to the reference information data creation program 32B (step 111).

When the transmission command flag is “0”, the controller 33 is in a stand-by state.

When the transmission command flag is “1”, the controller 33 creates the menu information based on the type of a predetermined menu, according to the reference information data creation program 32B (step 112). For example, let us consider that the type of a predetermined menu includes “favorite ranking of women in thirties (first place to third place)” and “today's favorite ranking (first place to third place)”, as shown in FIG. 6. In this case, the controller 33 determines the first to third places in the decreasing order of order quantity, based on “order quantity in thirties” of the customer management information currently stored in the reference information database 32A. Thus, the menu information, containing the names of articles, photographs (images) thereof, and the rank order thereof, is created according to that determination. When the type of a predetermined menu is an article recommended by the shop side, the controller 33 creates the menu information containing the names of corresponding articles, photographs (images) thereof, and reasons for recommendation (comments), according to the presence or absence of comments described in the recommendation columns of recommended article information stored in the reference information database 32A. There are plural types of menus. The controller 33 updates the type of a menu every the transmission command flag stored in the transmission command table 32C becomes “1”.

Moreover, after transmitting the created menu information to the display terminal 40 via the communication section 31 (step 113), the controller 33 changes the transmission command flag stored in the transmission command table 32C to “0” (step 114). In the display terminal 40, the controller 43 receives menu information from the server 30 and then manifests it on the display 42. For example, the names and photographs (images) of articles (“Kamonabe chowder (a Japanese food including duck meat boiled with soy-bean curd), Nikujyaga, and Kimuchinabe chowder (a food including meats and vegetables boiled with kimuchi) in the favorite ranking of women in thirties and articles (Kamonabe chowder, Oden (a Japanese food boiled in kelp-based broth seasoned with soy sauce), and Umani (a Japanese food including fish and vegetables boiled in thick soy with sugar)) in today's favorite ranking are displayed on the display 42 (step 115), as shown in FIG. 6.

Thereafter, the controller 33 changes the transmission command flag stored in the transmission command table 32C into “1” periodically (e.g. every 30 seconds), according to the reference information data creation program 32B. Thus, the controller 33 changes the setting of the menu type to be displayed on the display 42 in the display terminal 40 (step 116).

The menu displaying system according to the second embodiment will be explained below.

In the first embodiment, the case where the shop side originates information about articles to the customer has been described. However, in the second embodiment, a customer chooses information about an article using the input section of the display terminal to display information about the selected article on the display thereof.

The menu displaying system according to the second embodiment will be explained below.

The menu displaying system in the second embodiment differs from that in the first embodiment in the controller of the server and the controller of the display terminal. Other basic configuration is similar to that in the first embodiment. Hence, the duplicate explanation will be omitted here.

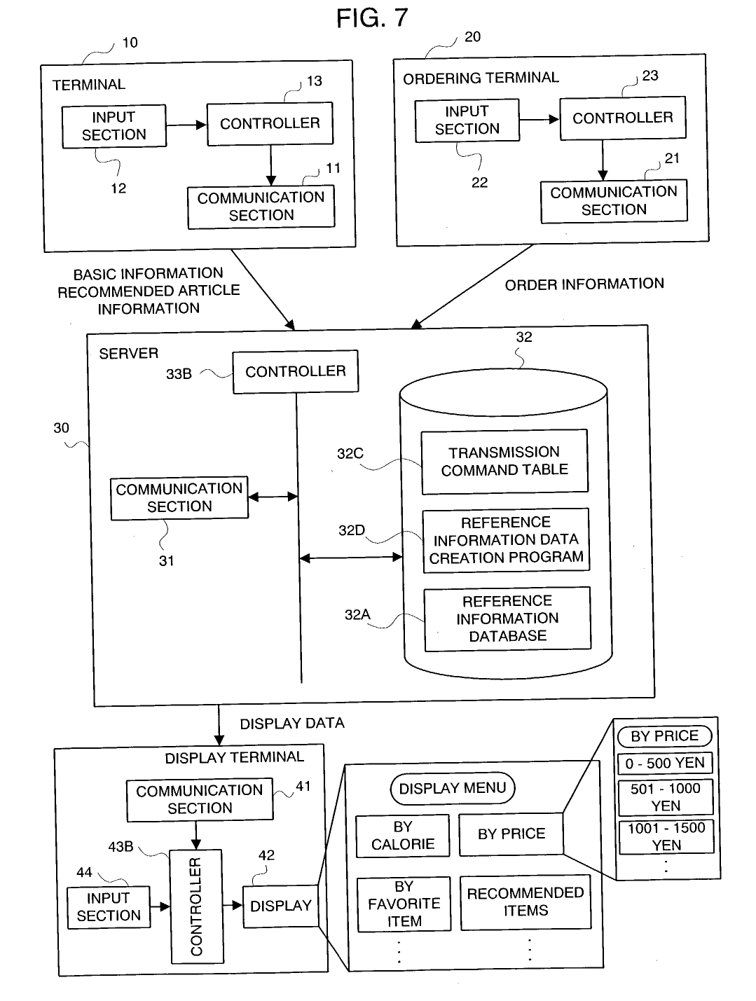

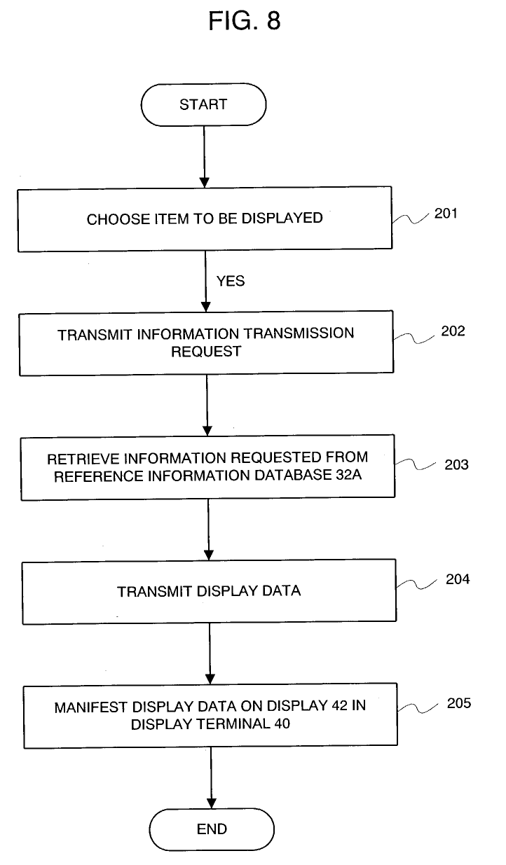

FIG. 7 is a block diagram illustrating the menu displaying system according to the second embodiment. FIG. 8 is a flowchart explaining the operation of the system in the second embodiment.

The storage 32 stores reference information data creation program 32D. Based on an information transmission request from the display terminal 40, the requested information is retrieved from the reference information database 32A in the storage 32. The reference information data creation program 32D directs the controller 33 to transmit the retrieved information acting as menu information to the display terminal 40.

In response to the information transmission request transmitted from the display terminal 40, the controller 33B in the server 30 retrieves the requested information from the reference information database 32A in the storage 32, based on the received information transmission request. Then, the controller 33B transmits the retrieved information acting as menu information to the display terminal 40.

When the input section 44 chooses a menu item to be displayed on the display 42 from among the menu items displayed thereon, the controller 43B in the display terminal 40 transmits an information transmission request to the server 30 via the communication section 41. The information transmission request is one of requesting transmitting information related to a chosen menu item.

In the menu item, an item classified “by calorie” (or the names or photographs of articles arranged by calorie) and an item classified by price (or the names or photographs of articles arranged by price) are displayed as shown in FIG. 7.

In succession, the operation of the menu displaying system in the second embodiment will be described below by referring to FIG. 8.

In brief explanation of the operation of the second embodiment, the case where a customer finds information about articles (dishes) within 500 yen will be described below.

Using the input section 44, as shown in FIG. 7, the customer chooses the item “by price” from among menu items displayed on the display 42 in the display terminal 40. The customer chooses, for example, the item of “0 to 500 yen”, from among the menu items in the price range (0 to 500 yen, 501 to 1,000 yen, 1001 to 1,500 yen, . . . ) indicated on the display 42 (step 201). Thus, the controller 43B transmits the information transmission request for transmitting information about articles in the “0 to 500 yen” price range, to the server 30 via the communication section 41 (step 202).

The controller 33B, which has received the information transmission request from the display terminal 40, retrieves the names of items in “0 to 500 yen” price range from among the basic information stored in the reference information database 32A in the storage 32, according to the reference information data creation program 32D (step 203). Thus, the controller 33B transmits as menu information the names and photographs (images) of the retrieved items to the display terminal 40 (step 204).

When receiving the menu information from the server 30, the controller 43B in the display terminal 40 displays the received menu information on the display 42 (step 205). The display 42 displays the names and photographs (images) of the articles in the “0 to 500 yen” price range.

In the second embodiment as described above, the customer can quickly browse the information about his/her desired items on the display terminal 40 installed at each customer's table.

It should be noted that the present invention is not limited only to the configurations in the first embodiment and in the second embodiment. For example, the configuration in the second embodiment may be combined with the configuration in the first embodiment.

Next, the menu displaying system in the third embodiment will be described below.

In the first and second embodiments, the case where the display terminal installed on each customer's table displays the menu of items has been explained above. However, installing the display terminal on each customer's table may lead to increasing the equipment expenses. In order to solve such a problem, the ordering terminal in the third embodiment is used not only as a customer 's order inputting device but also as the display terminal in the first embodiment.

The system according to the third embodiment will be in detail below.

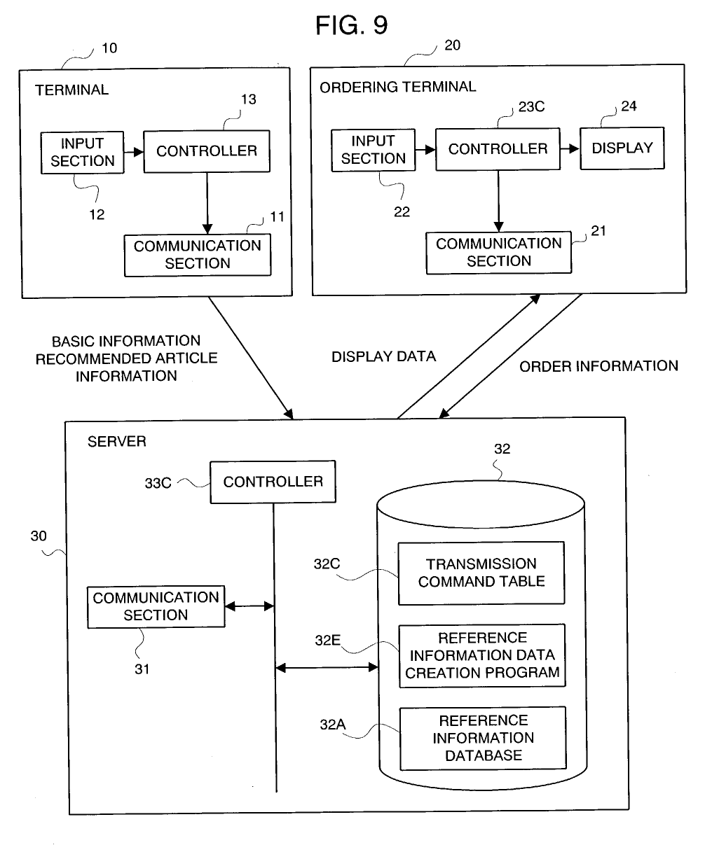

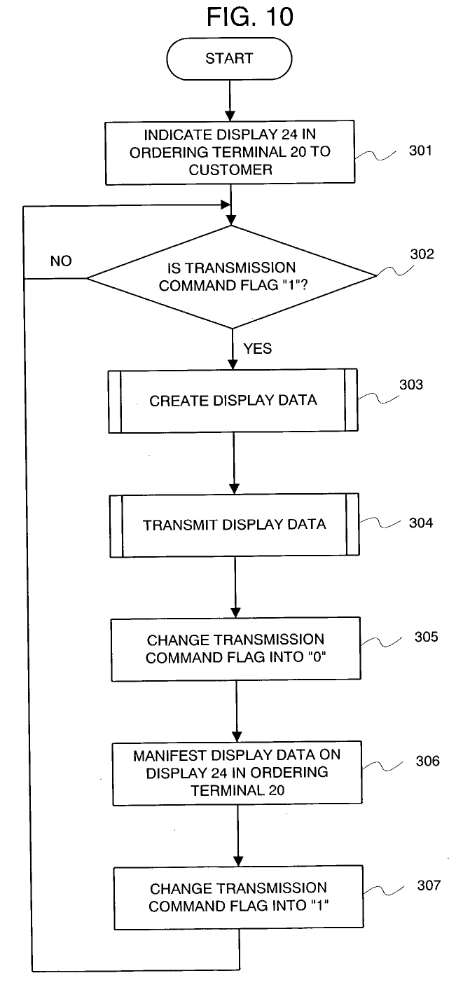

FIG. 9 is a block diagram illustrating a menu display system. FIG. 10 is a flowchart explaining the operation of the system in the third embodiment.

In the third embodiment, the display terminal is similar to that of the first embodiment in configuration. Hence, the detail configuration of the display terminal is omitted here.

The controller 23C in the ordering terminal 20 transmits the order information and the customer information input to the input section 22 to the server 30 via the communication section 21. The controller 23C receives menu information from the server 30 via the communication section 41 and then manifests it on the display 24.

The reference information data creation program 32E stored in the storage 32 directs the controller 33C in the server 30 within the reference information database 32A to update the reference information database 32A according to article information from the input terminal 10 or according to order information and customer information from the ordering terminal 20. Moreover, the reference information data creation program 32E directs the controller 33C in the server 30 to create menu information based on basic information, recommended article information and/or order management information stored in the reference information database 32A, in accordance with the transmission command flag stored in the transmission command table 32C. Moreover, the program 32E directs the controller 33C to transmit the created menu information to the ordering terminal 20. Moreover, the program 32E directs the controller 33C to rewrite the transmission command flag stored in the transmission command table.

In response to article information from the input terminal 10 or order information and customer information from the ordering terminal 20, the controller 33C in the server 30 updates the reference information database 32A according to the reference information data creation program 32E. The controller 33C checks whether or not the transmission command flag stored in the transmission command table 32C is “1” according to the reference information data creation program 32E. When the transmission command flag is “1”, the controller 33C creates menu information according to the type of a predetermined menu. Then the controller 33C transmits the created menu information to the ordering terminal 20 via the communication section 31.

In succession, the operation of the menu displaying system with the above-mentioned configuration will be explained below by referring to FIG. 10.

First, the operation of updating the reference information database 32A stored in the storage 32 within the server 30 will be explained below.

A waiter enters information about an article to the input section 12 of the input terminal 10. In this operation, the controller 13 in the input terminal 10 transmits an update request requesting the updating of the reference information database 32A in the server 30 as well as the article information input to the input section 12, to the server 30 via the communication section 11.

According to the reference information data creation program 32E, the controller 33 in the server 30 waits the update request transmitted from the input terminal 10 or order information and customer information, which are transmitted from the ordering terminal 20.

In response to the update request from the input terminal 10, the controller 33 updates basic information and/or recommended article information stored in the reference information database 32A, based on the article information transmitted together with the update request, according to the reference information data creation program 32E.

In answer to the customer's order, the waiter enters both the order information and the customer information to the input section 22 of the ordering terminal 20. The controller 23 in the ordering terminal 20 transmits the order information and the customer information input to the input section 22, to the server 30 via the communication section 21.

In succession, the controller 33 waits an update request transmitted from the input terminal 10 or both the order information or the customer information transmitted from the ordering terminal 20.

When the order information and the customer information are transmitted from the ordering terminal 20, the controller 33 updates the order management information stored in the reference information database 32A in the storage 32, according to the reference information data creation program 32E.

Updating at any time the reference information database 32A in the storage 32 within the server 30 is similar to that in the first embodiment.

When taking orders at a customer table and recommends specific items to the customer, the waiter indicates the display 24 in the ordering terminal 20 to the customer (step 301).

The controller 33C in the server 30 checks whether or not the transmission command flag stored in the transmission command table 32C is “1” according to the reference information data creation program 32E (step 302).

When the transmission command flag is “0”, the controller 33C in the server 30 stands by without any processing.

When the transmission command flag is “1”, the controller 33C creates menu information based on the type of a predetermined menu, according to the reference information data creation program 32E (step 303). For example, let us now consider that the type of a predetermined menu corresponds to an article menu recommended by the shop side. In such a case, the controller 33 creates menu information according to the presence or absence of comments in the recommendation column associated with the recommended article information stored in the reference information database 32A, as shown in FIG. 3. That menu contains the names of items (e.g. Nikujyaga and Ikanatto (a Japanese food containing squid and fermented soybeans)) recommended by a shop side, photographs (images) of the items, and reasons for recommendation (e.g. “potatoes newly received”, “new item during demonstration”).

The controller 33C transmits the created menu information to the ordering terminal 20 via the communication section 31 (step 304).

Thereafter, the controller 33C changes the transmission command flag stored in the transmission command table 32C into “0” (step 305).

The controller 23C in the ordering terminal 20, which has received the menu information from the server 30, displays the received menu information on the display section 24. For example, the names of items (e.g. Nikujyaga and Ikanatto), photographs (images) of the items, and reasons for recommendation (e.g. “potatoes newly received”, “new item during demonstration”) are displayed on the display 24 in the ordering terminal 20 (step 306).

Thereafter, the controller 33C in the server 30 changes the transmission command flag stored in the transmission command table 32C to “1” periodically (e.g. every five seconds), in accordance with the reference information data creation program 32E. Thus, the setting of the type of a menu manifested on the display 24 in the ordering terminal 20 is changed (step 307).

According to the present invention, unlike the paper-made menu card, information about items recommended by the shop side can be shown to the customer in real time.

Moreover, because the menu can be displayed on the display terminal, together with the order conditions, information about the favorite article ranking counted for one hour or information about the favorite article ranking classified by age can be provided.

Moreover, information about customer-desired items, such as information about items classified by price, can be displayed quickly.

The shop owner can easily grasp the order conditions, thus effectively stocking goods. For that reason, the shop owner can effectively sell goods, thus improving the profit ratio.

The entire disclosure of Japanese Application Patent No. 2001-393146 filed on Dec. 26, 2001 including specification, claims, drawings and summary are incorporated herein by reference in its entirely.

What is claimed is:

1 A menu displaying system comprises
an ordering terminal;
a display terminal installed at a customer table;
a server; and
a communication line for interconnecting said ordering terminal, said display terminal, and said server;
said ordering terminal including:
input means for inputting order information about an order from a customer and customer information about a feature of said customer; and
transmission means for transmitting the order information and the customer information input by said input means, to said server;
said server including:
a storage for storing article information about articles and order management information representing the order quantity of articles classified according to customer's features, in one-to-one correspondence; and
a controller for updating the order quantity of said order management information based on order information and customer information transmitted from said order terminal, creating menu information representing sales of articles according to a customer's feature based on the article information and the order management information stored in said storage, and then transmitting said menu information to said display terminal;
said server including a display for manifesting menu information transmitted from said server.

2 The menu displaying system defined in claim 1, wherein said display terminal comprises input means for choosing a predetermined menu item from among menu items for article information display manifested on said display, and a controller for controllably transmitting an article information transmission request to said server, said request requesting transmitting article information about said menu item chosen with said input means to its own terminal; and wherein said controller in said server retrieves required article information from said storage, based on said article information transmission request from said display terminal, and then transmits the retrieved article information as menu information to said display terminal.

3 A menu displaying system comprises
an ordering terminal;
a server; and
a communication line for interconnecting said ordering terminal and said server;
said ordering terminal including:
input means for inputting order information about an order from a customer and customer information about a feature of said customer;
a display for manifesting menu information; and
transmission means for transmitting the order information and the customer information input by said input means, to said server and manifesting menu information transmitted from said server;
said server including:
a storage for storing article information about articles and order management information representing the order quantity of articles classified according to customer's features, in one-to-one correspondence; and
a controller for updating the order quantity of said order management information stored in said storage based on order information and customer information transmitted from said order terminal, creating menu information representing sales of articles according to a customer's feature based on the article information and the order management information stored in said storage, and then transmitting said menu information to said ordering terminal.

4 The menu displaying system defined in any one of claims 1 to 3, further comprising an input terminal including input means for inputting recommendation information about an article recommended to a customer and transmission means for transmitting the recommendation information input by said input means to said server; and wherein said controller in said server updates article information stored in said storage based on said recommendation information from said server and then creates menu information about the article recommended to said customer based on said article information stored in said storage.

5 A menu displaying method suitable for a system including an ordering terminal, a server, and a display terminal installed at a customer table, said method comprising the steps of:
storing article information about articles and order management information into said server in one-to-one correspondence, said order management information representing the order quantity of articles according to customer's features;
transmitting order information about orders and customer information about customer's features, input in said ordering terminal, to said server;
updating said order management information stored in said server, based on the order information and the customer information from said ordering terminal;
creating menu information, based on said article information and said order management information stored in said server, said menu information representing article sales according to customer's features;
transmitting said menu information created in said server to said display terminal; and
manifesting the menu information from said server on said display terminal.

6 The menu displaying method defined in claim 5, further comprising the steps of:
when a predetermined menu item is chosen from among menu items representing article information on said display terminal, transmitting an article information transmission request to said server, said article information transmission request requesting transmitting article information about said chosen menu item to its own terminal;
retrieving requested article information from said storage in said server, based on said article information transmission request from said display terminal;
transmitting said article information retrieved as menu information to said display terminal by means of said server; and
manifesting menu information from said server, in said display terminal.

7 A menu displaying method suitable for a system including an ordering terminal and a server; said method comprising the steps of:
storing article information about articles and order management information into said server in one-to-one correspondence, said order management information representing the order quantity of articles according to customer's features;
transmitting order information about orders input in said ordering terminal and customer information about customer's features to said server;
updating order management information stored in said server, based on the order information and the customer information from said ordering terminal;
creating menu information based on the article information and the order management information stored in said server, said menu information representing article sales according to customer's features;
transmitting said menu information created in said server, to said ordering terminal; and
manifesting the menu information from said server, in said ordering terminal.

8 The menu displaying method defined in any one of claims 5 to 7, further comprising the steps of:
inputting recommendation information about articles recommended to customers in said input terminal;
transmitting said recommendation information input in said input terminal;
updating article information stored in said server based on said recommendation information from said input terminal; and
creating menu information about articles recommended to customers, based on display information stored in said server.
